(19) United States
(12) Patent Application Publication
(10) Pub. No.: US 2025/0178005 A1
(43) Pub. Date: Jun. 5, 2025

(54) TURBINE DRIVE FOR A ROTARY ATOMIZER, AND ASSOCIATED OPERATING METHOD

(71) Applicant: Dürr Systems AG, Bietigheim-Bissingen (DE)

(72) Inventors: Arved Hess, Konstanz (DE); Tobias Kleinhans, Benningen (DE); Josip Kutnjak, Stuttgart (DE); Bernhard Seiz, Lauffen (DE); Harry Krumma, Bönnigheim (DE)

(21) Appl. No.: 18/843,718

(22) PCT Filed: Mar. 1, 2023
(86) PCT No.: PCT/EP2023/055198

§ 371 Date: Sep. 4, 2024

(30) Foreign Application Priority Data
Mar. 15, 2022 (DE) 10 2022 105 999.5

(51) Int. Cl. B05B 5/04

(52) U.S. Cl. CPC B05B 5/0415

(57) ABSTRACT

The disclosure relates to a turbine drive for a rotary atomizer, having a rotatable turbine wheel with a plurality of turbine blades, a first drive nozzle for delivering a drive gas, in particular compressed air, to the turbine blades of the turbine wheel, to drive the turbine wheel, a first drive gas supply for supplying the drive gas to the first drive nozzle, and a second drive nozzle for discharging the drive gas onto the turbine blades of the turbine wheel to drive the turbine wheel. The disclosure additionally provides a second drive gas supply for supplying the drive gas to the second drive nozzle, wherein the second drive gas supply is separate from the first drive gas supply, so that the second drive nozzle can be supplied with the drive gas independently of the first drive nozzle.

### CROSS-REFERENCE TO RELATED APPLICATIONS

This application is a national stage of, and claims priority to, Patent Cooperation Treaty Application No. PCT/EP2023/055198, filed on Mar. 1, 2023, which application claims priority to German Application No. DE 10 2022 105 999.5, filed on Mar. 15, 2022, which applications are hereby incorporated herein by reference in their entireties.

### FIELD

The disclosure relates to a turbine drive for a rotary atomizer and a corresponding operating method.

### BACKGROUND

In modern paint shops for painting vehicle body components, rotary atomizers driven by compressed air driven turbines are usually used as application devices. One such turbine is known, for example, from EP 1 388 372 A1. This known turbine has a rotatably mounted turbine wheel with numerous turbine blades that are distributed around the circumference of the turbine wheel. To drive the rotary atomizer, the turbine blades are supplied with compressed air, which emerges from several drive nozzles distributed around the circumference of the turbine wheel. The turbine wheel can also be braked. For this purpose, brake air is discharged in the opposite direction from a brake nozzle onto the turbine blades. This known turbine already works satisfactorily, but there is still an interest in increasing the efficiency of the turbine.

With regard to the state of the art, reference should also be made to WO 2016/062365 A1, EP 1 384 516 A2 and DE 44 25 229 A1 and DE 101 15 469 A1.

### BRIEF DESCRIPTION OF THE DRAWINGS

FIG. 1 shows a schematic representation of a turbine drive for a rotary atomizer according to the disclosure.

FIG. 2 shows a modification of FIG. 1.

FIG. 3 shows a further modification of FIGS. 1 and 2.

FIGS. 4A-4C show various views of a turbine for a rotary atomizer according to the disclosure.

FIG. 5 shows a schematic representation of a turbine drive according to the disclosure, which operates the turbine in an optimum operating range depending on the respective load point.

FIG. 6 shows a flow chart to illustrate the operating method according to the disclosure.

FIG. 7 shows a modification of a turbine drive according to the disclosure.

FIG. 8 shows a further modification of a turbine drive according to the disclosure.

Finally, FIG. 9 shows a modification of a turbine drive according to the disclosure with a bistable spring element.

### DETAILED DESCRIPTION

The disclosure is based on the technical-physical discovery that the turbine in a rotary atomizer is often not operated at an optimum load point during operation, whereby the load point is determined by the speed and torque.

For example, when painting the interior surfaces of vehicle body parts, only a relatively low paint flow is emitted, so that a correspondingly low mechanical drive power of the turbine is required.

On the other hand, when painting the exterior of vehicle body components, relatively large areas are painted, which is why a correspondingly large paint flow is applied, which in turn requires a relatively high mechanical drive power of the turbine of the rotary atomizer.

The disclosure is based on the discovery that the turbine nozzles are better optimized for a specific load point in terms of shape and nozzle cross-section, so that the various load points that occur during operation of a rotary atomizer mean that the turbine is not always operated at its optimum load point. However, operating the turbine at a non-optimal load point leads to a reduction in the efficiency of the turbine. For example, optimizing the turbine for external painting leads to relatively poor efficiency for internal painting. Conversely, optimizing the turbine for internal painting leads to relatively poor efficiency for external painting.

The disclosure therefore provides for the turbine to have various drive nozzles which can be supplied with the respective drive gas (e.g. compressed air) from separate drive gas supply lines, so that the various drive nozzles can be activated or deactivated independently of one another. Depending on the respective load point, one or the other drive nozzles can then be activated. This makes it possible to operate the turbine in an optimum operating state even at changing load points, thereby increasing the efficiency of the turbine at changing load points.

For example, certain drive nozzles can be optimized for exterior painting, while other drive nozzles are optimized for interior painting. For exterior painting, the drive nozzles that are optimized for exterior painting are then selected. For interior painting, on the other hand, those drive nozzles that are optimized for interior painting are specifically selected.

The turbine drive according to the disclosure is designed for a rotary atomizer, as is known from the prior art and is described, for example, in EP 1 388 372 A1.

Thus, in accordance with the known turbine drive, the turbine drive according to the disclosure has a rotatable turbine wheel with several turbine blades. In a preferred embodiment of the disclosure, the turbine is designed as a radial turbine, but in principle it is also possible to design it as an axial turbine.

In addition, in accordance with the known turbine described at the beginning, the turbine according to the disclosure has at least two drive nozzles in order to supply the turbine blades of the rotatable turbine wheel with a drive gas (e.g. compressed air) in order to drive the turbine wheel.

The disclosure now provides for the various drive nozzles to be supplied with the drive gas from different drive gas supply lines, the drive gas supply lines being separate from one another so that the drive nozzles can be supplied with the drive gas independently of one another. This makes it possible to select the most suitable drive nozzle depending on the respective load point of the turbine drive and to supply it with the drive gas, while the other drive nozzles are deactivated and are not supplied with the drive gas. The disclosure thus enables a targeted selection and activation or deactivation of the individual drive air nozzles depending on the load point in order to optimize the efficiency of the turbine according to the load point.

In the preferred embodiment of the disclosure, three different drive nozzles and three drive gas supplies are provided, which are separate from one another and can be operated independently of one another. However, the disclosure is not limited to a specific number of drive nozzles and separate drive gas supplies. Thus, more than three drive nozzles and correspondingly more than three drive gas supplies can also be provided.

For example, several groups of drive nozzles can also be provided, whereby the drive nozzles of the individual groups are each supplied with the drive gas (e.g. compressed air) by a common drive gas supply. For example, a first group of drive nozzles can be optimized for exterior painting, while a second group of drive nozzles is optimized for interior painting. Depending on the type of painting (exterior painting/interior painting), the drive nozzles of one of the two groups are then selected and supplied with the drive gas, while the drive nozzles of the other group are then inactive.

It should also be mentioned that the various drive nozzles are preferably different, for example in terms of their nozzle shape and/or nozzle cross-section. This makes sense so that the most suitable drive nozzle for the flow onto the turbine blades of the turbine wheel can be selected depending on the respective load point. It should also be mentioned here that, as a rule, not just a single drive nozzle is selected. For example, several drive nozzles can be selected simultaneously according to the respective load point.

It should also be mentioned that the individual drive nozzles can preferably have a convergent-divergent nozzle cross-section. This means that the nozzle cross-section initially narrows convergently in the direction of flow and then widens divergently again, as is the case with a Laval nozzle, for example.

It was already mentioned at the beginning that the turbine wheel can also be braked by releasing a brake gas (e.g. compressed air) from a brake nozzle onto the turbine blades of the turbine wheel, whereby the brake nozzle is aligned in the opposite direction to the at least one drive nozzle. Such a brake nozzle is also preferably provided in the turbine drive according to the disclosure, which is preferably supplied with the respective brake gas (e.g. compressed air) from a brake gas supply via a brake gas control valve.

Furthermore, it has already been mentioned above that the drive nozzles are supplied with the respective drive gas (e.g. compressed air) individually or in groups via separate drive gas supply lines. A drive gas control valve is preferably arranged in each of the individual drive gas supply lines, which can be designed as a proportional valve, for example, and is preferably controlled pneumatically. However, instead of pneumatic actuation of the drive gas control valves, electrical or other actuation is also possible as an alternative.

Furthermore, within the scope of the disclosure, it is possible for a bistable spring element to be arranged in at least one of the drive gas supply lines, which either releases or blocks the respective drive gas supply line depending on its state. The bistable spring element is therefore a bistable valve, whereby the bistable spring element is preferably connected to the brake gas supply and changes its state in the event of a pressure pulse in the brake gas supply.

The concept of the bistable spring element can also be implemented with several drive nozzles, i.e. a bistable spring element can be arranged in each of the individual drive gas supply lines. However, there is then no efficient flow via the respective drive gas supply, as there is only a single brake gas supply.

Furthermore, the turbine drive according to the disclosure can have a gas heater in order to heat the drive gas and/or the brake gas (e.g. compressed air) upstream of the drive nozzles or upstream of the brake nozzle, whereby the gas heater is preferably arranged outside the rotary atomizer.

In one variant of the disclosure, the gas heater only heats the drive gas in one of the drive gas supply lines, while the drive gas in the other drive gas supply line(s) is not heated by the gas heater.

In another variant of the disclosure, on the other hand, the gas heater heats the drive gas in several and preferably in all drive gas supply lines.

The gas heater can, for example, be arranged upstream of the at least one drive gas control valve. Alternatively, however, it is also possible for the gas heater to be arranged downstream behind the at least one drive gas control valve.

Furthermore, it should be mentioned that the turbine drive according to the disclosure preferably also has a turbine controller which receives a load point on the input side, the load point determining the speed and/or the torque of the turbine drive. On the output side, the turbine controller then controls the drive gas control valves as a function of the load point. Here, the turbine controller specifically selects the drive nozzles that promise optimum turbine efficiency at the respective load point.

For example, the turbine controller can open a different number of drive gas control valves depending on the load point and close the remaining drive gas control valves. Depending on the load point, the turbine controller can therefore not only select the most suitable drive nozzle, but also vary the number of selected drive nozzles according to the load point in order to increase the efficiency of the turbine.

For example, with three drive nozzles, the turbine controller can set one of the following operating states depending on the respective load point:
Only the first drive gas control valve is open, while the other drive gas control valves are closed, so that only the first drive nozzle emits the drive gas.
Only the second drive gas control valve is open, while the other drive gas control valves are closed, so that only the second drive nozzle emits the drive gas.
Only the third drive gas control valve is open, while the other drive gas control valves are closed, so that only the third drive nozzle emits the drive gas.
Only the first drive gas control valve and the second drive gas control valve are open, while the third drive gas control valve is closed, so that only the first drive nozzle and the second drive nozzle emit the drive gas.
Only the first drive gas control valve and the third drive gas control valve are open, while the second drive gas control valve is closed, so that only the first drive nozzle and the third drive nozzle dispense the drive gas.
Only the second drive gas control valve and the third drive gas control valve are open, while the first drive gas control valve is closed, so that only the second drive nozzle and the third drive nozzle dispense the drive gas.
All drive gas control valves are open so that all drive nozzles dispense the drive gas.

Furthermore, the turbine drive according to the disclosure can have several drive gas shut-off valves in order to release or shut off the drive gas flows separately and independently of one another. In this case, a common drive gas proportional valve is preferably provided which serves to adjust the sum of the individual drive gas flows, the drive gas proportional valve then being arranged upstream of the drive gas shut-off valves.

The disclosure claims protection for the turbine drive described above, whereby the protection extends to the individual turbine, the rotary atomizer with such a turbine and the turbine drive as a whole, which can also include the turbine controller, the air heater and other components. The term turbine drive used in the context of the disclosure can thus refer to the individual turbine, the rotary atomizer with such a turbine or the complete turbine drive.

In addition, however, the disclosure also claims protection for a corresponding operating method for such a turbine drive, whereby the individual steps of the operating method according to the disclosure are already apparent from the above description, so that a separate description can be dispensed with and reference is made to the above description for this purpose.

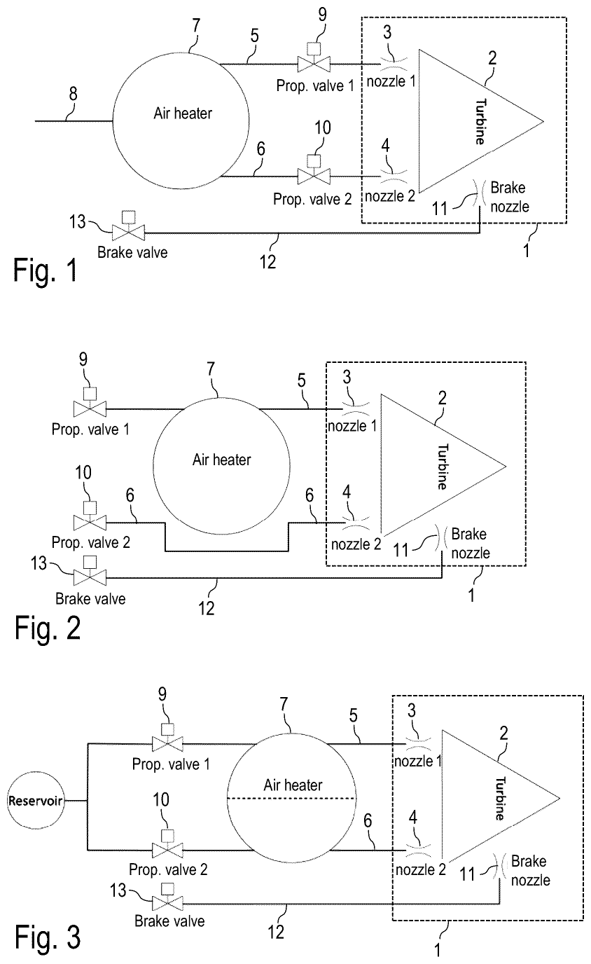

In the following, the embodiment example of a turbine drive according to the disclosure as shown in FIG. 1 is first described.

The turbine drive is used to drive a rotary atomizer 1, which is used for painting vehicle body components in a paint shop. For this purpose, the rotary atomizer 1 contains a turbine 2, which is largely of conventional design, as described, for example, in EP 1 388 372 A1, so that reference is also made to this publication.

Thus, the turbine 2 has a rotatably mounted turbine wheel with numerous turbine blades which are distributed around the circumference of the turbine wheel. The turbine blades of the turbine wheel can be supplied with compressed air from two drive nozzles 3, 4 in order to drive the turbine wheel and thus the rotary atomizer 1.

The two drive nozzles 3, 4 are supplied with compressed air from a compressed air supply 8 via separate drive gas supply lines 5, 6 and an air heater 7, which can be referred to as a compressed air reservoir, compressed air compressor or pressure vessel.

A drive gas control valve 9, 10 is arranged in each of the two drive gas supply lines 5, 6, which can control the flow of drive gas to the individual drive nozzles 3, 4 independently of one another. In this design example, the drive gas control valves 9, 10 are designed as proportional valves that can be actuated pneumatically or electrically, for example.

Depending on the respective load point, the two drive gas control valves 9, 10 can then be controlled independently of each other in order to control the two drive nozzles 3, 4 accordingly. The control is carried out in such a way that optimum efficiency of the turbine 2 is achieved depending on the respective load point.

In addition, the turbine 2 has a brake nozzle 11, which makes it possible to brake the turbine wheel by blowing compressed air onto the turbine blades of the turbine wheel. The brake nozzle 11 is therefore aligned in the opposite direction to the two drive nozzles 3, 4.

The brake nozzle 11 is supplied with compressed air via a brake gas supply 12 and a brake gas control valve 13.

The embodiment example according to FIG. 2 largely corresponds to the embodiment example described above and shown in FIG. 1, so that reference is made to the above description in order to avoid repetition, whereby the same reference signs are used for corresponding individual features.

A feature of this embodiment example is that the two drive gas control valves 9, 10 are arranged upstream of the air heater 7, whereas the two drive gas control valves 9, 10 are located downstream of the air heater 7 in the embodiment example shown in FIG. 1.

A further feature of this embodiment example is that the air heater 7 only heats the compressed air in the drive gas supply 5, whereas the other drive gas supply 6 is routed around the air heater 7.

The embodiment example according to FIG. 3 largely corresponds to the embodiment examples described above and shown in FIGS. 1 and 2, so that reference is made to the above description in order to avoid repetition, whereby the same reference symbols are used for corresponding details.

A feature of this embodiment example is that the air heater 7 enables separate and independent heating of the compressed air in the two drive gas supply lines 5, 6. For example, the compressed air in the drive gas supply 5 can be heated more than the compressed air in the other drive gas supply 6.

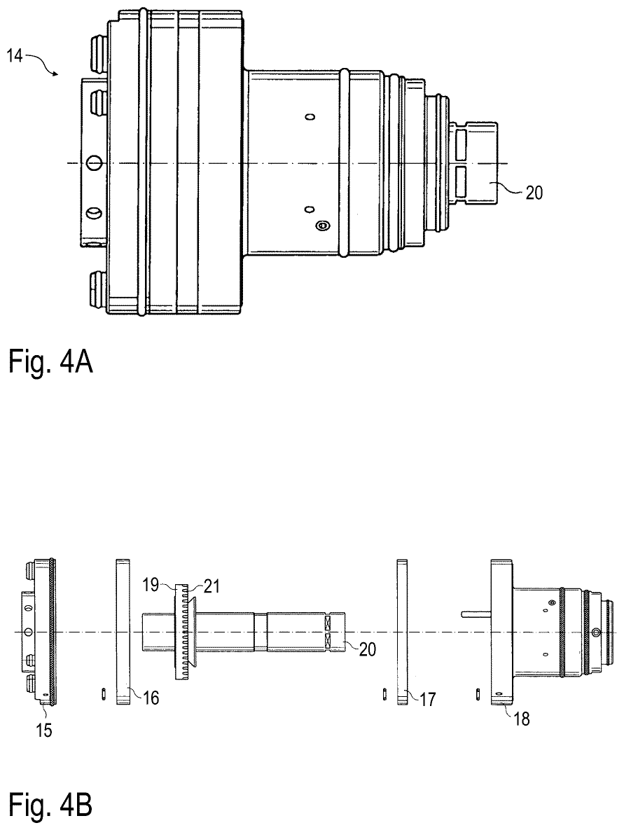

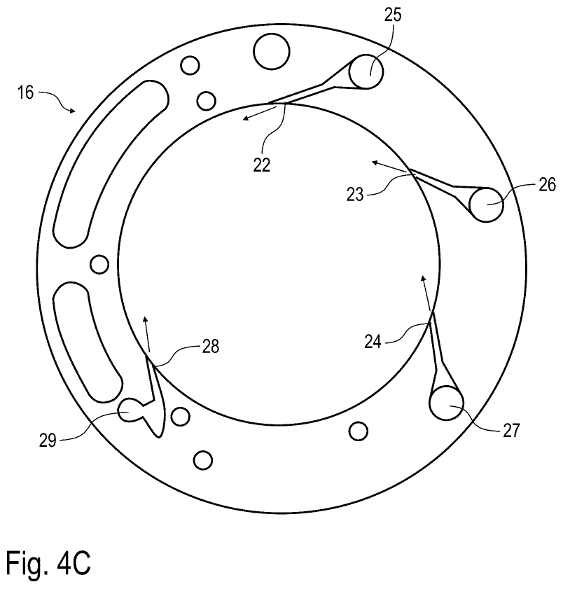

FIGS. 4A-4C show various views of a turbine 14 according to the disclosure, as is known in a similar form from EP 1 388 372 A1, so that reference is also made to this publication.

Thus, the turbine 14 has several housing parts 15-18 which, in the assembled state, accommodate a turbine wheel 19 with a turbine shaft 20 and numerous turbine blades 21, wherein the turbine blades 21 are arranged distributed over the circumference of the turbine wheel 19.

FIG. 4C shows that the individual turbine blades 21 of the turbine wheel 19 can be supplied with compressed air from three drive nozzles 22-24 in order to drive the turbine wheel 19, as is known from the prior art. The drive nozzles 22-24 are arranged in the housing part 16 and are designed differently in terms of number, nozzle cross-section and shape in order to enable adaptation to the respective load point of the turbine 14 by selecting the suitable drive nozzle 22-24.

In addition, there are three separate and mutually separated drive gas supply lines 25-27 in the housing part 16 in order to be able to supply the three drive nozzles 22-24 with compressed air independently of one another. This makes it possible to select one or more of the drive nozzles 22-24 as a function of the respective load point of the turbine 14 in order to achieve the greatest possible efficiency of the turbine 14.

Furthermore, it can also be seen from FIG. 4C that a brake nozzle 28 is also formed in the housing part 16 of the turbine 14, which is fed with compressed air from a brake gas supply 29. The brake nozzle 28 on the one hand and the drive nozzles 22-24 on the other hand are aligned in opposite directions according to their function (drive or braking).

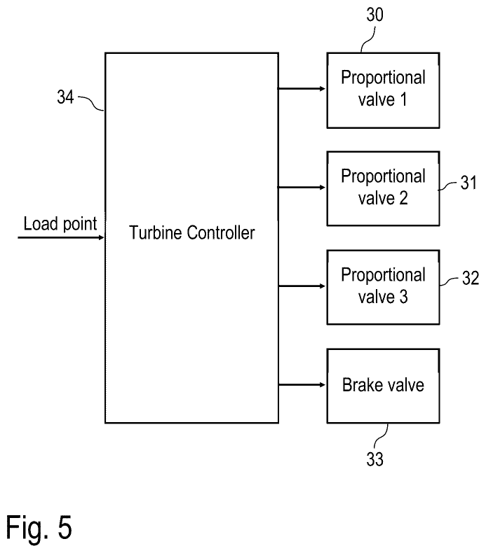

FIG. 5 shows a schematic representation of a turbine drive according to the disclosure with three proportional valves 30-32 for controlling three drive nozzles, which are not shown here for the sake of simplicity.

In addition, a brake valve 33 is shown in order to supply a brake nozzle with compressed air, whereby the brake nozzle is not shown here for the sake of simplicity.

The proportional valves 30-32 and the brake valve 33 are controlled by a turbine controller 34 as a function of the respective load point in such a way that the turbine has the greatest possible efficiency.

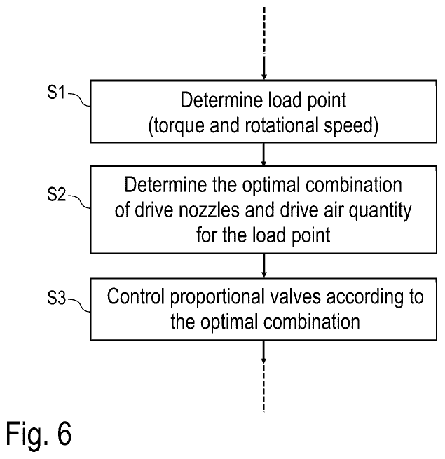

FIG. 6 shows a flow diagram to explain the operating method according to the disclosure.

In a first step S1, the respective load point of the turbine, which is defined by torque and speed, is first determined.

In the next step S2, the optimum combination of drive nozzles and drive air volume for the load point is determined.

In the next step S3, the proportional valves for the individual drive nozzles are controlled according to the optimum combination.

In this way, the turbine can also be operated very efficiently at different load points.

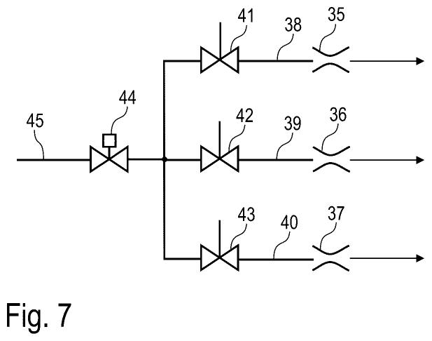

FIG. 7 shows a schematic representation of a turbine drive according to the disclosure with three drive nozzles 35-37, which are supplied with compressed air via three separate drive gas supply lines 38-40.

A drive gas control valve 41-43 is arranged in each of the individual drive gas supply lines 38-40, so that the drive nozzles 35-37 are controlled independently of one another. The gas heater can be connected upstream or downstream in separate chambers.

The drive gas supply lines 38-40 are brought together on the input side via a proportional valve 44 and are supplied with compressed air from a common compressed air supply 45.

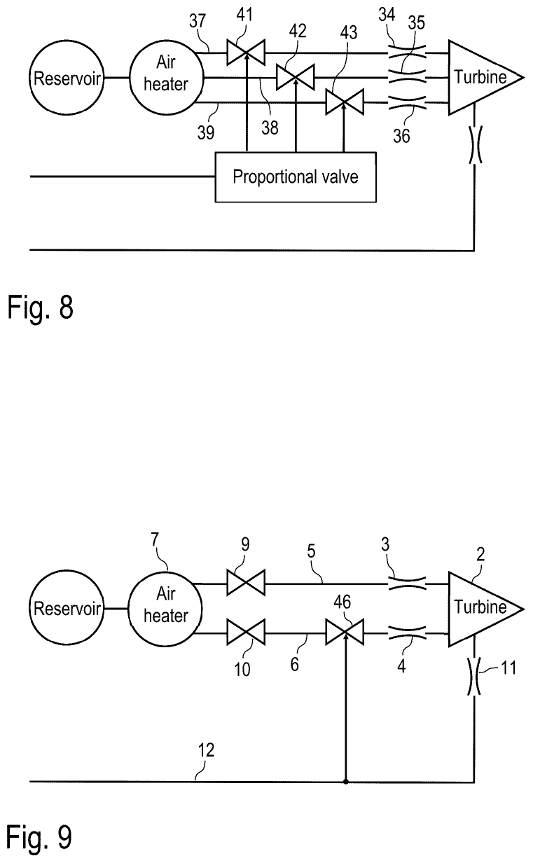

FIG. 8 shows a schematic representation of a turbine drive according to the disclosure, which largely corresponds to the embodiments described above, so that reference is made to the above description in order to avoid repetition, with the same reference signs being used for corresponding details.

A feature of this embodiment example is that the drive gas control valves 41-43 are proportional valves which are pneumatically actuated.

Finally, FIG. 9 shows a further embodiment example of a turbine drive according to the disclosure, which also largely corresponds to the embodiment examples described above, so that reference is made to the above description in order to avoid repetition, whereby the same reference signs are used for corresponding details.

A feature of this embodiment example is that a bistable spring element 46 is arranged in the one drive gas supply 6, which is connected to the brake gas supply 12 and switches between two stable states in the event of a pressure pulse in the brake gas supply 12, namely between a first state in which the bistable spring element 46 blocks the drive gas supply 6 and a second state in which the bistable spring element 46 releases the drive gas supply 6.

The disclosure is not limited to the preferred embodiments described above. Rather, a large number of variants and modifications are possible which also make use of the inventive concept and therefore fall within the scope of protection. In particular, the disclosure also claims protection for the subject matter and the features of the dependent claims independently of the claims referred to in each case and, in particular, also without the features of the main claim. The disclosure thus comprises various aspects of the disclosure which enjoy protection independently of each other.

1.-18. (canceled)

19. A turbine drive for a rotary atomizer, comprising
a) a rotatable turbine wheel with a plurality of turbine blades,
b) a first drive nozzle for delivering a drive gas, in particular compressed air, to the turbine blades of the turbine wheel to drive the turbine wheel,
c) a first drive gas supply for supplying the drive gas to the first drive nozzle, and
d) a second drive nozzle for delivering the drive gas to the turbine shafts of the turbine wheel to drive the turbine wheel,
e) a second drive gas supply for supplying the drive gas to the second drive nozzle, the second drive gas supply being separate from the first drive gas supply, so that the second drive nozzle can be supplied with the drive gas independently of the first drive nozzle.

20. The turbine drive according to claim 19, further comprising
a) a third drive nozzle for delivering the drive gas to the turbine blades of the turbine wheel to drive the turbine wheel, and
b) a third drive gas supply for supplying the drive gas to the third drive nozzle, the third drive gas supply being separate from the first drive gas supply and from the second drive gas supply, so that the third drive nozzle can be supplied with the drive gas independently of the first drive nozzle and independently of the second drive nozzle.

21. The turbine drive according to claim 19, wherein the first drive nozzle and the second drive nozzle are different.

22. The turbine drive according to claim 21, wherein first drive nozzle and the second drive nozzle are different with respect to their nozzle shape and/or with respect to their nozzle cross-section.

23. The turbine drive according to claim 20, wherein the first drive nozzle and the second drive nozzle and the third drive nozzle have a convergent-divergent nozzle cross-section.

24. The turbine drive according to claim 19, further comprising at least one brake nozzle for delivering a brake gas to the turbine blades of the turbine wheel in order to brake the turbine wheel, the brake nozzle being oriented in the opposite direction to the at least one drive nozzle, and.

25. The turbine drive according to claim 24, further comprising a brake gas control valve for controlling the brake gas flow to the brake nozzle.

26. The turbine drive according to claim 24, further comprising a brake gas supply for supplying the brake gas.

27. The turbine drive according to claim 20, further comprising
a) a first drive gas control valve for controlling the drive gas flow through the first drive gas supply to the first drive nozzle, and
b) a second drive gas control valve for controlling the drive gas flow through the second drive gas supply to the second drive nozzle, and
c) a third drive gas control valve for controlling the drive gas flow through the third drive gas supply to the third drive nozzle.

28. The turbine drive according to claim 27, wherein
a) the first drive gas control valve is arranged outside the rotary atomizer,
b) the third drive gas control valve being arranged outside the rotary atomizer,
c) the second drive gas control valve is arranged outside the rotary atomizer.

29. The turbine drive according to claim 19, wherein a bistable spring element is arranged in at least one of the drive gas supplies, which either releases or blocks the respective drive gas supply depending on its state.

30. The turbine drive according to claim 29, wherein the bistable spring element is connected to the brake gas supply and changes its state in the event of a pressure pulse in the brake gas supply.

31. The turbine drive according to claim 19, further comprising a gas heater for heating the drive gas and/or the brake gas upstream of the drive nozzles and/or upstream of the brake nozzle.

32. The turbine drive according to claim 31, wherein the gas heater is arranged outside the rotary atomizer.

33. The turbine drive according to claim 31, wherein the gas heater only heats the drive gas in one of the drive gas supplies, while the drive gas in the other drive gas supply or supplies is not heated by the gas heater.

34. The turbine drive according to claim 31, wherein the gas heater heats the drive gas in several drive gas supply lines.

35. The turbine drive according to claim 31, wherein the gas heater is arranged upstream of the at least one drive gas control valve.

36. The turbine drive according to claim 31, wherein the gas heater is arranged downstream behind the at least one drive gas control valve.

37. The turbine drive according to claim 19, wherein
a) the turbine drive has a turbine controller,
b) the turbine controller receives a load point on the input side, the load point determining the speed and/or the torque of the turbine drive, and
c) the turbine controller controls the drive gas control valves on the output side as a function of the load point.

38. The turbine drive according to claim 37, wherein the turbine controller opens a different number of the drive gas control valves as a function of the load point and closes the remaining drive gas control valves.

39. The turbine drive according to claim 37, wherein the turbine controller sets one of the following operating states as a function of the load point:
a) only the first drive gas control valve is open, so that only the first drive nozzle discharges the drive gas,
b) only the second drive gas control valve is open, so that only the second drive nozzle emits the drive gas,
c) only the third drive gas control valve is open, so that only the third drive nozzle emits the drive gas,
d) only the first drive gas control valve and the second drive gas control valve are open, so that only the first drive nozzle and the second drive nozzle emit the drive gas,
e) only the first drive gas control valve and the third drive gas control valve are open, so that only the first drive nozzle and the third drive nozzle emit the drive gas,
f) only the second drive gas control valve and the third drive gas control valve are open, so that only the second drive nozzle and the third drive nozzle emit the drive gas,
g) all drive gas control valves are open so that all drive nozzles release the drive gas.

40. The turbine drive according to claim 19, further comprising
a) a plurality of drive gas shut-off valves for separately releasing or blocking the individual drive gas flows independently of one another, and
b) a common drive gas proportional valve for adjusting the sum of the individual drive gas flows, wherein the drive gas proportional valve is arranged upstream of the drive gas shut-off valves.

41. An Operating method for a turbine drive of a rotary atomizer, comprising:
a) discharging a first drive gas flow of a drive gas from a first drive nozzle onto turbine blades of a turbine wheel of an atomizer turbine, and
b) discharging a second drive gas flow of the drive gas from a second drive nozzle onto the turbine blades of the turbine wheel of the atomizer turbine,
c) separately controlling the first drive gas flow independently of the second drive gas flow.

42. The operating method according to claim 41, further comprising:
a) discharging a third drive gas flow of the drive gas from a third drive nozzle onto the turbine blades of the turbine wheel of the atomizer turbine, and
b) separate control of the third drive gas flow independently of the first drive gas flow and independently of the second drive gas flow.

43. The operating method according to claim 41, further comprising the following:
a) determining a load point of the turbine drive, the load point determining the speed and/or torque of the turbine drive, and
b) adjusting the first drive gas flow and the second drive gas flow and optionally also the third drive gas flow as a function of the load point.

44. The operating method according to claim 43, wherein a different number of the drive gas flows is switched on as a function of the load point.
